(19) United States
(12) Patent Application Publication
(10) Pub. No.: US 2018/0188481 A1
(43) Pub. Date: Jul. 5, 2018

(54) ULTRA WIDE-ANGLE LARGE APERTURE LENS

(71) Applicant: Anhui Changgeng Optics Technology Co., LTD., Hefei, Anhui (CN)

(72) Inventor: Dunwu ZUO, Chaohu, Anhui (CN)

(21) Appl. No.: 15/529,927

(22) PCT Filed: Nov. 4, 2016
(86) PCT No.: PCT/CN2016/104523

§ 371 Date: May 25, 2017

(30) Foreign Application Priority Data
Apr. 12, 2016 (CN) 201610228389.4

(51) Int. Cl. G02B 13/00; G02B 15/24; G02B 15/177; H04N 5/232

(52) U.S. Cl. CPC G02B 13/006; G02B 15/24; H04N 5/23296; G02B 15/177; G02B 13/0035

(57) ABSTRACT

An ultra wide-angle large-aperture lens sequentially comprises at least three parts from an object side to an image side: a first lens group G1, a second lens group G2, and a third lens group G3; when an object moves closer from infinity, the first lens group G1 is fixed, the second lens group G2 and the third lens group G3 move, to implement an ultra wide-angle microlens which is in focus and meets the following conditional expressions: 1.2≤(|F12|+S)/LB≤2.5(1); 0.8≤(|F12|+S)/(tan ω×LB)≤1.3(2).

### FIELD OF THE INVENTION

The Invention relates to a wide-angle lens whose full angle of view is over 110 degrees, which can be widely applied to digital camera lenses and video camera lenses, and especially to the field of single lens reflex camera lenses.

### BACKGROUND OF THE INVENTION

Currently, most of the commonly known wide-angle lenses with an angle of view over 100 degrees have a structure starting with a negative diopter. For example, the commonly known Japanese Patent Publication No. 2011-102871, starting from an object side, consists of a first lens group having a negative diopter, a second lens group having a positive diopter, and a third lens group having a positive diopter. When an object moves closer from infinity, the second lens group moves towards an image, and the third lens group moves towards the object to realize focusing. However, there are a lot of lenses in the first lens group and the second lens group, and especially, a second focusing quantity is too large, resulting in an excessively heavy weight of lenses and high focusing load, and a focusing speed cannot be ensured. Moreover, because there are too many lenses, the lens is large in size and high in costs, and cannot be regarded as a miniaturized high-performance wide-angle lens.

Further, the commonly known Japanese Patent Publication No. 2013-20073, starting from an object side, consists of a first lens group having a negative diopter, a second lens group having a negative diopter, and a third lens group having a positive diopter. When an object moves closer from infinity, the second group of lenses move towards an object space to realize focusing. As a spatial requirement for focusing needs to be guaranteed, enough space is needed for the first group of lenses and the second group of lenses; the angle of view of an ultra wide-angle lens is very large, which leads to an extremely large aperture of the first lens group, so that a miniaturized ultra wide-angle lens cannot be achieved.

### SUMMARY OF THE INVENTION

The technical problem to be solved by the Invention is to overcome existing technical defects, and the Invention provides a miniaturized, high-performance, low-cost ultra wide-angle large-aperture lens.

The Invention employs the following technical solution to solve the technical problem:
An ultra wide-angle large-aperture lens, including:
at least three parts sequentially from an object side to an image side: a first lens group G1 having a negative diopter, a second lens group G2 having a positive diopter or a negative diopter, and a third lens group G3 having a positive diopter, where when an object moves closer from infinity, the first lens group G1 is fixed, the second lens group G2 and the third lens group G3 move, to implement an ultra wide-angle microlens which is in focus and meets the following conditional expressions:

1.2≤(|F12|+S)/LB≤2.5 (1)

0.8≤(|F12|+S)/(tan ω×LB)≤1.3 (2)

where,
F12: a focal length after the first lens group G1 and the second lens group G2 are synthesized in an infinity state;
S: a distance from a front-most end surface from the object side of the first lens group to a diaphragm in the infinity state;
LB: a distance from a surface, which is closest to an image, to the image in the infinity state; and
ω: a half angle of view of an optical system.

Further, a conditional expression (3) is met:

0.2≤(D23+|F12|)/(tan ω×LB)≤0.6 (3)

where,
D23: an interval between the second lens group and the third lens group in the infinity state.

Further, a conditional expression (4) is met:

0.5≤F1/|F12|≤2 (4)

where,

F1: a focal length of a plus lens in the first lens group.

A surface, which is closest to the image, of the first lens group G1 is an aspheric surface.

Further, a shape of the aspheric surface meets conditional expressions (5) and (6):

1.8≤G2R/SG10≤3 (5)

5≤G2R/SG5≤10 (6)

where, as shown in FIG. 7,

G2R: a paraxial radius of curvature of a surface, which is closest to the image side, of the first lens group;

SG5: an arc height of the surface, which is closest to the image, of the first lens group when a distance from the center of an optical axis to an effective aperture is equal to half of the radius of curvature, namely G2R/2; and

SG10: an arc height of the surface, which is closest to the image, of the first lens group when the distance from the center of an optical axis to an effective aperture is equal to the radius of curvature G2R.

A full angle of view is over 110 degrees.

The conditional expressions are explained as follows:

If an upper limit of the conditional expression (1) is exceeded, the focal length of the first lens group is too long, or the diaphragm is too far away from the first lens group, and during implementation of a large angle of view, the aperture of the first lens group will become very large, which is adverse to miniaturization. If a lower limit of the conditional expression (1) is exceeded, although miniaturization can be achieved, aberration correction will be extremely difficult because the diopter of the first lens group is too strong or the diaphragm is too close to the first group, and a high-performance wide angle effect can hardly be obtained.

If an upper limit of the conditional expression (2) is exceeded, the focal length of the first lens group is too long, or the diaphragm is too far away from the first lens group, and during implementation of a large angle of view, the aperture of the first lens group will become very large, which is adverse to miniaturization. If a lower limit of the conditional expression (1) is exceeded, although miniaturization can be achieved, aberration correction will be extremely difficult because the diopter of the first lens group is too strong or the diaphragm is too close to the first group, and a high-performance wide angle effect can hardly be obtained.

If an upper limit of the conditional expression (3) is exceeded, the diopter of the first lens group is too weak or an interval between the second and third lens groups is too large, which may make it difficult to achieve an ultra wide angle of view and miniaturization at the same time. On the contrary, if a lower limit of the conditional expression (3) is exceeded, although the ultra wide angle of view is easy to achieve, the diopter of the first lens group is too strong, which may make aberration correction difficult, increase the number of lenses, and increase the costs.

If an upper limit of the conditional expression (4) is exceeded, a diopter of a concave lens of the first lens group will be too weak, resulting in difficulty in aberration correction of the second lens group, and infinity and proximity correction cannot be desirably achieved at the same time. On the contrary, if a lower limit of the conditional expression (4) is exceeded, the diopter of the second lens group is too weak, and the amount of movement for focusing is too large; as a result, a focusing distance is insufficient and miniaturization cannot be realized.

If an upper limit of the conditional expression (5) is exceeded, the aspheric surface on the image side of the first lens group is compensated excessively; although a distortion aberration can be corrected desirably, too many other aberrations such as astigmatism and coma may be generated. On the contrary, if a lower limit of the conditional expression (5) is exceeded, the aspheric surface on the image side of the first lens group is compensated insufficiently, more lenses are needed to compensate for other aberrations such as distortion aberration, and miniaturization or high performance cannot be achieved.

If an upper limit of the conditional expression (6) is exceeded, the aspheric surface on the image side of the first lens group is compensated excessively; although a distortion aberration can be corrected desirably, too many other aberrations such as astigmatism and coma may be generated. On the contrary, if a lower limit of the conditional expression (5) is exceeded, the aspheric surface on the image side of the first lens group is compensated insufficiently, more lenses are needed to compensate for other aberrations such as distortion aberration, and miniaturization or high performance cannot be achieved

The Invention has the following beneficial effects: a miniaturized, high-performance, and low-cost ultra wide-angle lens whose angle of view is over 110 degrees is provided.

### BRIEF DESCRIPTION OF THE DRAWINGS

FIG. 1 is a structural schematic view of Example 1 of the Invention;

FIG. 2 is a schematic view of aberrations and chromatic difference of Example 1 of the Invention;

FIG. 3 is a structural schematic view of Example 2 of the Invention;

FIG. 4 is a schematic view of aberrations and chromatic difference of Example 2 of the Invention;

FIG. 5 is a structural schematic view of Example 3 of the Invention;

FIG. 6 is a schematic view of aberrations and chromatic difference of Example 3 of the Invention; and

FIG. 7 is a schematic view of an arc height of a surface, which is closest to an image side, of a first lens group, and a radius of curvature.

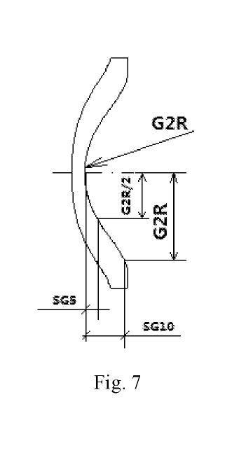

### DETAILED DESCRIPTION OF THE INVENTION

To make the technical measures, new creation features, and achieved objectives and effects of the Invention easy to understand, the following further illustrates the Invention with reference to specific drawings.

### EXAMPLE 1

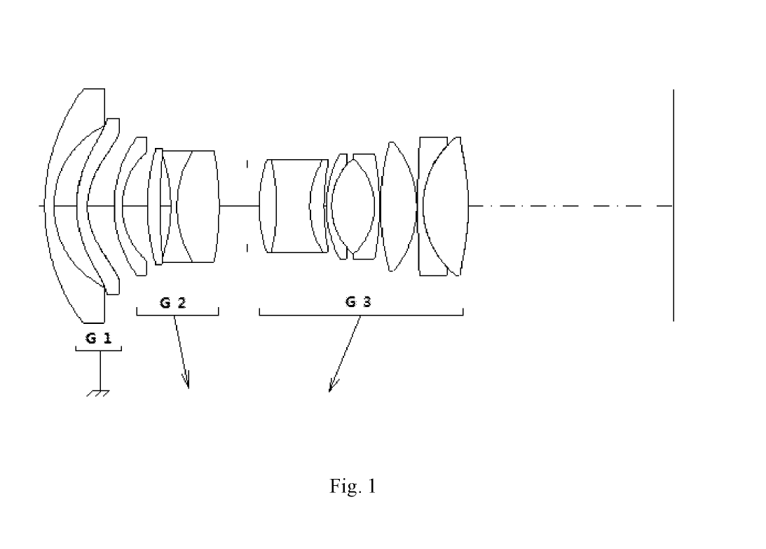

As shown in FIG. 1, an ultra wide-angle lens of Example 1 sequentially includes, from an object side, a first lens group G1 having a negative diopter, a second lens group G2 having a negative diopter, and a third lens group G3 having a positive diopter.

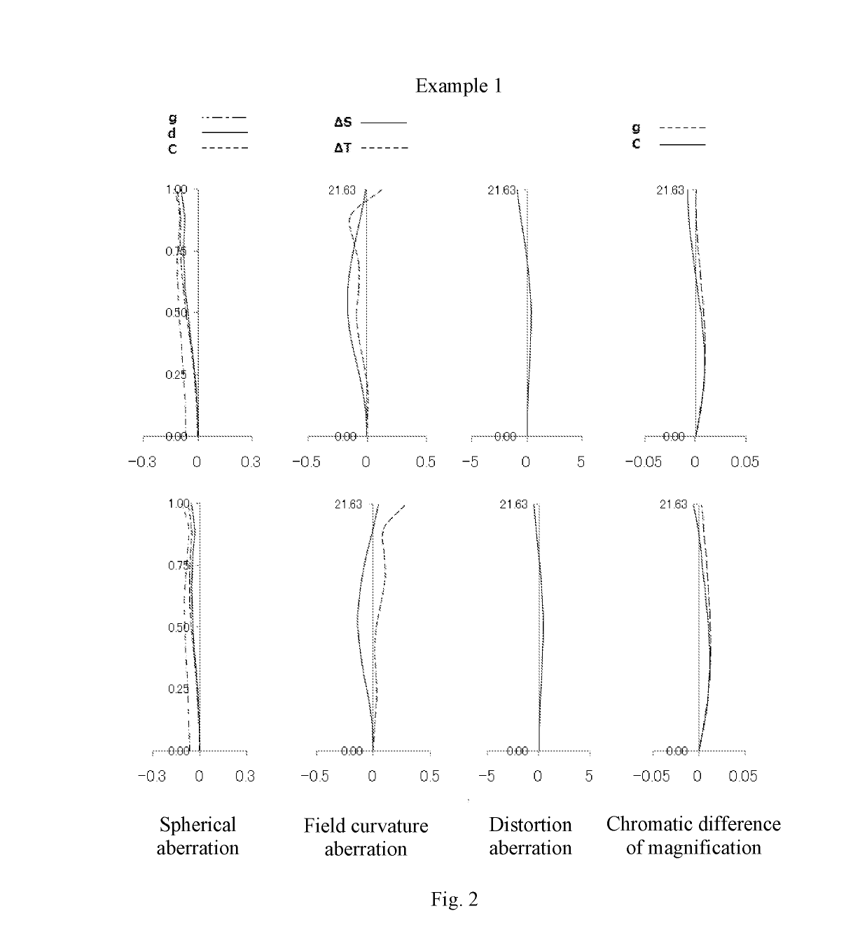

A spherical aberration, a field curvature aberration, a distortion aberration, and a chromatic difference of magnification at the maximum image magnification in an infinity state of Example 1 are as shown in FIG. 2.
Data of Example 1 is as follows:
R(mm): a radius of curvature of each surface
D(mm): an interval between lenses and lens thickness
Nd: a refractive index of each glass of line d
Vd: the Abbe number of glass
Focal length: 14.45
Fno: 2.87
Half angle of view ω: 56.5

| | Radius of | Interval | Refractive | Abbe |
|---|---|---|---|---|
| Surface | curvature R | thickness D | index Nd | number Vd |
| 1 | 36.5362 | 1.8000 | 1.74916 | 54.67 |
| 2 | 16.8329 | 4.3538 | | |
| 3 ★ | 22.2802 | 2.0000 | 1.80610 | 40.73 |
| 4 ★ | 13.1551 | (variable) | | |
| 5 | 21.8600 | 1.5000 | 1.92286 | 20.88 |
| 6 | 13.3977 | 4.8148 | | |
| 7 | 38.3679 | 2.2645 | 1.71736 | 29.50 |
| 8 | 85.9242 | 2.1034 | | |
| 9 | −31.0409 | 1.2000 | 1.49700 | 81.61 |
| 10 | 18.8780 | 8.0000 | 1.65293 | 36.96 |
| 11 | −55.7546 | (variable) | | |
| 12 Diaphragm | inf | 2.1500 | | |
| 13 | 25.9270 | 3.2856 | 1.62004 | 36.30 |
| 14 | −39.1219 | 6.2990 | 1.80420 | 46.50 |
| 15 | 16.3944 | 2.7253 | 1.84666 | 23.78 |
| 16 | 44.2831 | 0.4489 | | |
| 17 | 19.9599 | 1.0000 | 1.90366 | 33.00 |
| 18 | 12.0341 | 8.1020 | 1.49700 | 81.61 |
| 19 | −12.0341 | 1.0000 | 1.83481 | 42.72 |
| 20 | −52.1667 | 0.1500 | | |
| 21 | 44.2942 | 6.8895 | 1.49700 | 81.61 |
| 22 | −18.6742 | 0.1500 | | |
| 23 | 258.9417 | 1.0000 | 1.84400 | 37.34 |
| 24 | 16.5272 | 8.5741 | 1.58313 | 59.46 |
| 25 ★ | −39.1425 | (LB variable) | | |

Aspheric Surface

| | K | 4(B) | 6(C) | 8(D) | 10(E) | 12(F) |
|---|---|---|---|---|---|---|
| 3 | −0.0433 | 3.85146e−005 | −2.74884e−007 | 4.22706e−010 | −5.42847e−013 | −1.03343e−015 |
| 4 | −0.4853 | 1.54141e−005 | −3.80388e−007 | −1.97332e−009 | 1.06864e−011 | −1.69260e−014 |
| 25 | 0.3308 | 1.89790e−005 | 9.88484e−009 | 1.92025e−010 | −1.17296e−012 | 3.14002e−015 |

Definitions of shapes of the aspheric surface:

y: a radial coordinate starting from an optical axis.

z: an offset amount, starting from an intersection between the aspheric surface and the optical axis, in the direction of an optical axis.

r: a radius of curvature of a reference sphere of the aspheric surface.

K: aspheric coefficients of the 4^{th}, 6^{th}, 8^{th}, 10^{th}, and 12^{th} powers.

$$z = \frac{( 1 / r ) {y}^{2}}{1 + \sqrt{1 - ( 1 + K ) {( y / r )}^{2}}} + A 4 {y}^{4} + A 6 {y}^{6} + A 8 {y}^{8} + A 10 {y}^{10} + A 12 {y}^{12}$$

| Focal length | 14.4513 | 0.025 times |
|---|---|---|
| D(4) | 5.0702 | 5.5392 |
| D(11) | 5.4011 | 3.9097 |
| LB | 38.8100 | 39.8324 |

### EXAMPLE 2

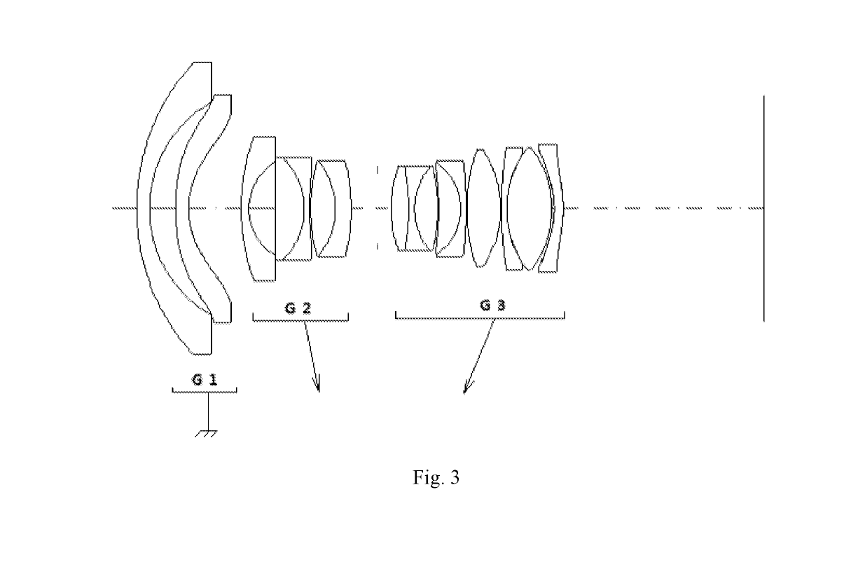

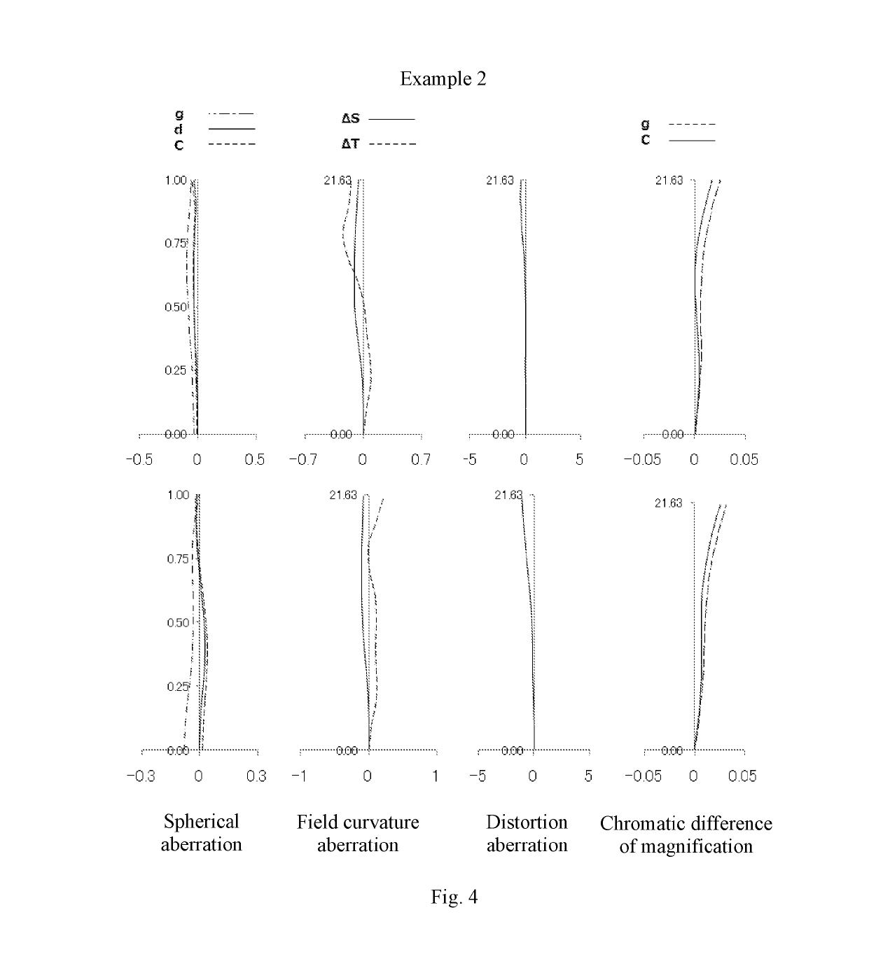

As shown in FIG. 3, an ultra wide-angle lens of Example 2 sequentially includes, from an object side, a first lens group G1 having a negative diopter, a second lens group G2 having a negative diopter, and a third lens group G3 having a positive diopter. A spherical aberration, a field curvature aberration, a distortion aberration, and a chromatic difference of magnification at the maximum image magnification in an infinity state of Example 2 are as shown in FIG. 4.
Data of Example 2 is as follows:
R(mm): a radius of curvature of each surface
D(mm): an interval between lenses and lens thickness
Nd: a refractive index of each glass of line d
Vd: the Abbe number of glass
Focal length: 12.5
Fno: 2.87
Half angle of view ω: 60.1

| | Radius of | Interval | Refractive | Abbe |
|---|---|---|---|---|
| Surface | curvature R | thickness D | index Nd | number Vd |
| 1 | 41.3919 | 2.5000 | 1.74916 | 54.67 |
| 2 | 23.5576 | 5.0658 | | |
| 3 ★ | 51.6496 | 2.5000 | 1.58313 | 59.46 |
| 4 ★ | 16.7988 | (variable) | | |
| 5 | 39.7839 | 1.5000 | 1.49700 | 81.61 |
| 6 | 10.4818 | 5.1866 | | |
| 7 | 0.0000 | 5.5315 | 1.62588 | 35.74 |
| 8 | −13.8133 | 1.0000 | 1.83481 | 44.72 |
| 9 | 70.3450 | 0.2000 | | |
| 10 | 32.3483 | 4.8664 | 1.76182 | 26.61 |
| 11 | −14.1918 | 3.0000 | 1.92286 | 20.88 |
| 12 | −37.8109 | (variable) | | |
| 13 diaphragm | inf | 2.6149 | | |
| 14 | 24.8151 | 3.3000 | 1.61293 | 36.96 |
| 15 | −43.5495 | 1.2000 | 1.91082 | 35.25 |
| 16 | 12.4551 | 4.5000 | 1.62004 | 36.30 |
| 17 | −33.5744 | 0.1500 | | |
| 18 | −59.4780 | 4.2676 | 1.78472 | 25.72 |
| 19 | −10.6778 | 1.0000 | 1.90366 | 29.31 |
| 20 | −83.4618 | 0.1500 | | |
| 21 | 34.0377 | 6.6000 | 1.49700 | 81.61 |
| 22 | −19.9445 | 0.1500 | | |
| 23 | 77.2021 | 1.0000 | 1.91082 | 35.25 |
| 24 | 19.2911 | 8.7000 | 1.49700 | 81.61 |
| 25 | −19.2911 | 0.5000 | | |
| 26 ★ | −15.8048 | 1.7000 | 1.80781 | 40.97 |
| 27 ★ | −23.9742 | (LB variable) | | |

Aspheric Surface

| | K | 4(B) | 6(C) | 8(D) | 10(E) | 12(F) |
|---|---|---|---|---|---|---|
| 3 | 0.0080 | 5.00208e−005 | −1.48696e−007 | 2.85395e−010 | −3.26206e−013 | 5.77197e−017 |
| 4 | −0.5807 | 2.41854e−005 | 1.14397e−008 | −1.61462e−009 | 4.64271e−012 | −4.16529e−015 |
| 26 | 0.4154 | 1.60608e−004 | −3.90127e−007 | 1.97932e−009 | −1.00952e−011 | 5.34069e−014 |
| 27 | −11.4671 | 3.56937e−005 | 3.58224e−007 | −4.31857e−009 | 2.03624e−011 | −3.90187e−014 |

Definitions of shapes of the aspheric surface:
y: a radial coordinate starting from an optical axis.
z: an offset amount, starting from an intersection between the aspheric surface and the optical axis, in the direction of an optical axis.
r: a radius of curvature of a reference sphere of the aspheric surface.
K: aspheric coefficients of the 4^{th}, 6^{th}, 8^{th}, 10^{th}, and 12^{th} powers.

$$z = \frac{( 1 / r ) {y}^{2}}{1 + \sqrt{1 - ( 1 + K ) {( y / r )}^{2}}} + A 4 {y}^{4} + A 6 {y}^{6} + A 8 {y}^{8} + A 10 {y}^{10} + A 12 {y}^{12}$$

| Focal length | 12.500 | 0.02 times |
|---|---|---|
| D(4) | 10.1074 | 10.1118 |
| D(12) | 5.1500 | 4.6207 |
| LB | 38.8325 | 39.3529 |

### EXAMPLE 3

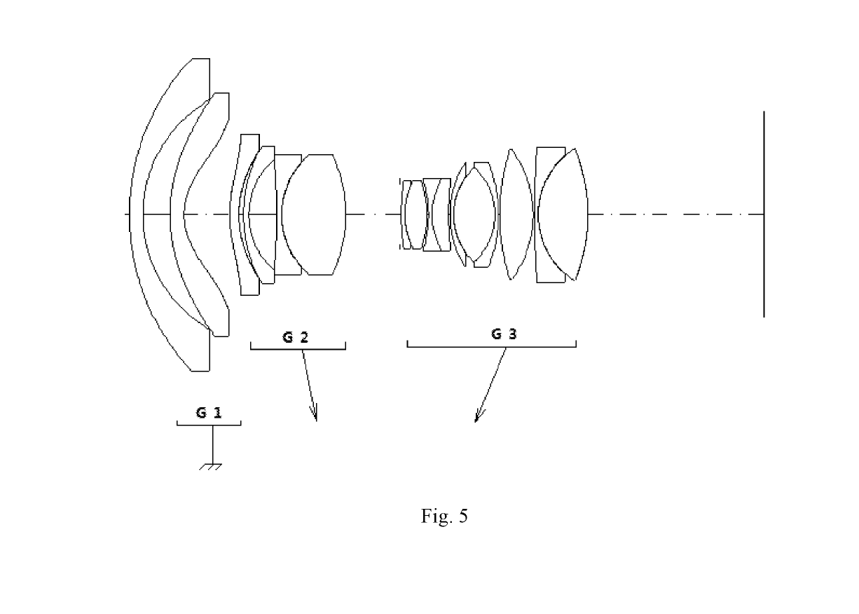

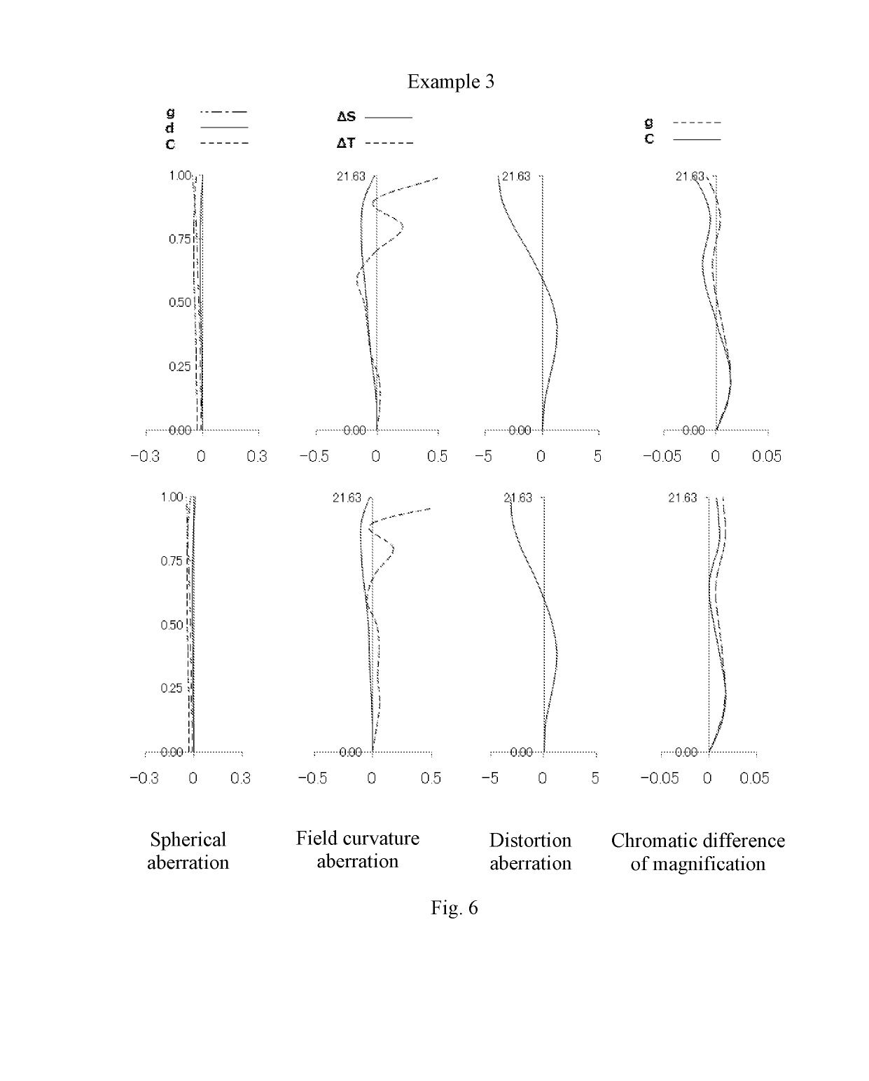

As shown in FIG. 5, an ultra wide-angle lens of Example 3 sequentially includes, from an object side, a first lens group G1 having a negative diopter, a second lens group G2 having a positive diopter, and a third lens group G3 having a positive diopter, a spherical aberration, a field curvature aberration, a distortion aberration, and a chromatic difference of magnification at the maximum image magnification in an infinity state of Example 3 are as shown in FIG. 6.
Data of Example 3 is as follows:
R(mm): a radius of curvature of each surface
D(mm): an interval between lenses and lens thickness
Nd: a refractive index of each glass of line d
Vd: the Abbe number of glass
Focal length: 12.34
Fno: 2.87
Half angle of view ω: 65.3

| | Radius of | Interval | Refractive | Abbe |
|---|---|---|---|---|
| Surface | curvature R | thickness D | index Nd | number Vd |
| 1 | 49.1688 | 3.0000 | 1.88300 | 40.80 |
| 2 | 28.7369 | 5.9510 | | |
| 3 ★ | 38.3771 | 3.0000 | 1.76222 | 39.10 |
| 4 ★ | 13.2216 | (variable) | | |
| 5 ★ | 26.3504 | 2.0000 | 1.80610 | 40.73 |
| 6 ★ | 21.9484 | 1.0000 | | |
| 7 | 29.0498 | 1.2000 | 1.92286 | 20.88 |
| 8 | 15.7852 | 6.0387 | | |
| 9 | −155.4907 | 1.2000 | 1.49700 | 81.61 |
| 10 | 17.3034 | 14.0589 | 1.60460 | 34.14 |
| 11 | −30.1628 | (variable) | | |
| 12 Diaphragm | inf | 0.3000 | | |
| 13 | 51.0241 | 0.8000 | 1.88300 | 40.80 |
| 14 | 16.2177 | 4.8578 | 1.61685 | 32.93 |
| 15 | −22.3133 | 0.3000 | | |
| 16 | −26.5661 | 0.8000 | 1.88300 | 40.80 |
| 17 | 15.3661 | 3.6600 | 1.92286 | 20.88 |
| 18 | 60.4796 | 0.3000 | | |
| 19 | 21.2781 | 0.8000 | 1.91082 | 35.25 |
| 20 | 14.2411 | 8.9962 | 1.49700 | 81.61 |
| 21 | −14.2411 | 0.8000 | 1.91082 | 35.25 |
| 22 | −31.0060 | 0.3000 | | |
| 23 | 45.1155 | 7.3580 | 1.49700 | 81.61 |
| 24 | −23.5371 | 0.3000 | | |
| 25 | 208.2211 | 0.8000 | 1.90366 | 31.31 |
| 26 | 16.9897 | 10.9515 | 1.58037 | 66.66 |
| 27 ★ | −33.0129 | (LB variable) | | |

Aspheric Surface

| | K | 4(B) | 6(C) | 8(D) | 10(E) | 12(F) |
|---|---|---|---|---|---|---|
| 3 | 0.0000 | 1.08543e−005 | −6.58994e−008 | 1.76009e−010 | −2.50521e−013 | 1.39500e−016 |
| 4 | −1.1525 | −5.06484e−006 | −9.76877e−008 | 8.42213e−012 | 3.75716e−013 | −3.58386e−016 |
| 5 | −6.9451 | −2.98647e−005 | 8.67891e−008 | −7.99109e−011 | −4.26182e−013 | 7.25791e−016 |
| 6 | 1.0036 | −5.24665e−005 | 2.72339e−007 | −1.42729e−009 | 6.56722e−012 | −2.77682e−014 |
| 27 | 0.0000 | 1.02224e−005 | −5.86171e−009 | 4.23996e−011 | −4.86295e−014 | −5.96462e−016 |

Definitions of shapes of the aspheric surface:

y: a radial coordinate starting from an optical axis.

z: an offset amount, starting from an intersection between the aspheric surface and the optical axis, in the direction of an optical axis.

r: a radius of curvature of a reference sphere of the aspheric surface.

K: aspheric coefficients of the 4^{th}, 6^{th}, 8^{th}, 10^{th}, and 12^{th} powers.

$$z = \frac{( 1 / r ) {y}^{2}}{1 + \sqrt{1 - ( 1 + K ) {( y / r )}^{2}}} + A 4 {y}^{4} + A 6 {y}^{6} + A 8 {y}^{8} + A 10 {y}^{10} + A 12 {y}^{12}$$

| Focal length | 10.3417 | 0.02 times |
|---|---|---|
| D(4) | 10.0602 | 10.2346 |
| D(11) | 11.8296 | 11.4532 |
| LB | 38.6008 | 38.8027 |

Summary Table of Conditional Expressions

| | Exam- | Exam- | Exam- |
|---|---|---|---|
| | ple 1 | ple 2 | ple 3 |
| Conditional expression (1): | 1.480 | 1.661 | 2.334 |
| 1.2 ≤ (\|F12\| + S)/LB ≤ 2.5 | | | |
| Conditional expression (2): | 0.980 | 0.955 | 1.073 |
| 0.8 ≤ (\|F12\| + S)/(tanω × LB) ≤ 1.3 | | | |
| Conditional expression (3): | 0.452 | 0.380 | 0.511 |
| 0.2 ≤ (D23 + \|F12\|)/(tanω × LB) ≤ 0.6 | | | |
| Conditional expression (4): | 1.077 | 1.499 | 0.645 |
| 0.5 ≤ F1/\|F12\| ≤ 2 | | | |
| Conditional expression (5): | 2.317 | 2.187 | 2.296 |
| 1.8 ≤ G2R/SG10 ≤ 3 | | | |
| Conditional expression(6): | 7.767 | 7.466 | 8.164 |
| 5 ≤ G2R/SG5 ≤ 10 | | | |

Basic principles and main features of the Invention as well as advantages of the Invention are shown and described above. Those skilled in the art should understand that the Invention is not limited to the foregoing Examples. The above Examples and the description in the specification are merely used for illustrating the principle of the Invention, and the Invention may further have various changes and improvements without departing from the spirit and scope of the Invention. All these changes and improvements fall in the protection scope of the Invention. The protection scope of the Invention is defined by the appended claims and equivalencies thereof.

1. An ultra wide-angle large-aperture lens, comprising:
at least three parts sequentially from an object side to an image side: a first lens group G1 having a negative diopter, a second lens group G2 having a positive diopter or a negative diopter, and a third lens group G3 having a positive diopter, wherein when an object moves closer from infinity, the first lens group G1 is fixed, the second lens group G2 and the third lens group G3 move, to implement an ultra wide-angle microlens which is in focus and meets the following conditional expressions:
1.2≤(|F12|+S)/LB≤2.5 (1)
0.8≤(|F12|+S)/(tan ω×LB)≤1.3 (2)
wherein,
F12: a focal length after the first lens group G1 and the second lens group G2 are synthesized in an infinity state;
S: a distance from a front-most end surface from the object side of the first lens group to a diaphragm in the infinity state;
LB: a distance from a surface, which is closest to an image, to the image in the infinity state; and
ω: a half angle of view of an optical system.

2. The ultra wide-angle large-aperture lens according to claim 1, wherein a conditional expression (3) is met;
0.2≤(D23+|F12|)(tan ωLB)≤0.6 (3)
wherein,
D23: an interval between the second lens group and the third lens group in the infinity state.

3. The ultra wide-angle large-aperture lens according to e claim 1, wherein a conditional expression (4) is met;
0.5≤F1/|F12|≤2 (4)
wherein,
F1: a focal length of a plus lens in the first lens group.

4. The ultra wide-angle large-aperture lens according to claim 1, wherein a surface, which is closest to the image, of the first lens group G1 is an aspheric surface.

5. The ultra wide-angle large-aperture lens according to claim 4, wherein a shape of the aspheric surface meets conditional expressions (5) and (6):
1.8≤G2R/SG10≤3 (5)
5≤G2R/SG5≤10 (6)
wherein,
G2R: a paraxial radius of curvature of a surface, which is closest to the image side, of the first lens group;
SG5: an arc height of the surface, which is closest to the image, of the first lens group when a distance from the center of an optical axis to an effective aperture is equal to half of the radius of curvature, namely G2R/2; and
SG10: an arc height of the surface, which is closest to the image, of the first lens group when the distance from the center of an optical axis to an effective aperture is equal to the radius of curvature G2R.

6. The ultra wide-angle large-aperture lens according to claim 1, wherein a full angle of view is over 110 degrees.
